(19) United States
(12) Patent Application Publication
(10) Pub. No.: US 2003/0183066 A1
(43) Pub. Date: Oct. 2, 2003

(54) Keyboard for electronic musical instruments

(76) Inventor: Rainer Gallitzendörfer, Grunwald (DE)

Correspondence Address: SENNIGER POWERS LEAVITT AND ROEDEL, ONE METROPOLITAN SQUARE, 16TH FLOOR, ST LOUIS, MO, 63102, US

(21) Appl. No.: 10/312,381

(22) PCT Filed: Jul. 2, 2001
(86) PCT No.: PCT/EP01/07550

(30) Foreign Application Priority Data
Jul. 4, 2000 (DE) 100 31 794.4

(51) Int. Cl. G10H 1/34

(52) U.S. Cl. 84/745

(57) ABSTRACT

The keyboard for electronic musical instruments provides a solenoid coil (4) for every key (1), which is excited with pulse-width modulated signals by a control circuit (8). A plunger (5) of the solenoid is coupled mechanically with the key, respectively. When the solenoid coil is being excited, the plunger (5) pushes the key (1) towards an upper limit position. Furtheron, the solenoid coil serves as a sensor for the measuring of the key position by evaluation of the progress of the electric current through the solenoid coil, or by evaluating the reverse-bias voltage induced by the coil of the solenoid (4) during the pulse pauses of the control signal. The control circuit (8) changes the pulse width of the control signals dependent on the sensed position, whereby the key characteristics can be modified.

### BACKGROUND OF THE INVENTION

The invention relates to a keyboard for electronic musical instruments.

For keyboards for electronic musical instruments it is desired to simulate the characteristics of the mechanical keyboard as good as possible, e.g. concerning mass inertia, pressure threshold point, which are commonly defined as “keyboard characteristics”. For example, pianos with keys actuating on hammers have a very characteristic pressure threshold point while the key can be pressed down more easily again, after the hammer has reached its final position. In contrast, other musical keyboard instruments, like organs or cembali, have other characteristics.

Finally, even pianos of different manufacturers have each an own characteristic which can be felt absolutely by a trained pianist.

U.S. Pat. No. 5,783,765 describes a keyboard for electronic musical instruments where the single keys are coupled mechanically with a plunger or anchor of an electromagnetic solenoid device. In addition, every key is balanced to a predefined position by two springs acting towards opposite directions. A separate position sensor is assigned to every key which evaluates the key's position.

Depending on the output signals of the position sensors, the solenoids are excited in that they exert a force on the assigned key acting against the key pressure executed by the performer. This position-dependent “reverse force” is freely programmable for the configuration of the keyboard characteristics. As position sensors, elastic plate members are suggested there, which are coupled with one of the springs.

Sensing of the key position by several other measuring methods, like condensator (U.S. Pat. No. 3,943,812, U.S. Pat. No. 4,027,569), semiconductors (U.S. Pat. No. 4,276,538), conductive rubber (U.S. Pat. No. 4,615,252), electrodes (UYS 4,628,786), resistive elements (U.S. Pat. No. 4,649,784), switches (U.S. Pat. No. 4,884,073), piezo-electrical films (U.S. Pat. No. 5,237,125) , optical sensors (U.S. Pat. No. 5,524,521), and photo-interrupters (U.S. Pat. No. 5,641,925) is known from the prior art.

For the actuation of the individual keys of the keyboard, the usage of solenoids is known from U.S. Pat. No. 4,031,796; U.S. Pat. No. 4,524,669; U.S. Pat. No. 5,506,369; and U.S. Pat. No. 5,527,987).

U.S. Pat. No. 4,580,478, U.S. Pat. No. 4,838,139, and U.S. Pat. No. 4,765,218 suggest inductance coils for sensing of the key position.

The simulation of the key pressure threshold point by a mechanical method according to the principle of beating hammers is described in U.S. Pat. No. 4,217,803, U.S. Pat. No. 4,273,017, U.S. Pat. No. 4,890,533, U.S. Pat. No. 5,062,342, and U.S. Pat. No. 5,739,450. In U.S. Pat. No. 4,476,769, the pressure threshold point is simulated by forward-biased springs, in U.S. Pat. No. 5,204,486 by a guide bar.

U.S. Pat. No. 4,899,631 uses an electric motor which modifies the tension bias of a spring by a cable, while in turn the tension influences the characteristics of the keyboard. Finally, EP 0 567 024 A2 simulates the tactile impression of a piano by solenoids which generate a force acting in opposite direction to the key pressure exerted by the performer.

The object of the invention is to create a keyboard for musical instruments which is able to imitate any keyboard characteristics by simple means.

This object is solved by the characteristics specified in claim 1. Preferred embodiments and developments of the invention can be drawn from the subclaims.

The basic idea of the invention is the coupling of the key with a solenoid coil and to feed this coil with pulsewidth-modulated signals and by this to generate a mechanical reverse-acting force. Simultaneously, the coil is acting as a sensor for the key position, respectively. For the individual characteristics, the pulse to pause ratio of the control signal for the solenoid can be changed during the push down of the key to adjust the desired characteristic, accordingly.

According to a first variant of the invention, the back electromotive force (EMF) generated by the solenoid is sensed and evaluated during the pulse pause. According to a second variant of the invention, the current flowing through the solenoid coil is sensed and evaluated during the active pulses.

The essential advantages of the present invention are that the coil solenoid is being used as an active device for the mechanical force as well as an position sensor. By that, the production expense is kept low. There is no mechanical adjustment of an additional sensor required. The mechanical construcion is more robust, because less and robust parts can be used. In general, a solenoid coil is more mechanically robust than the sensors usually being applied. Futhermore, there is less wear of less moveable parts which can fatigue or age. By using a pulse width modulated control signal, the digital technology utilized at present electronic musical instruments can be used especially good, making digital-to-analog converters mostly unnecessary. Merely for the sensing of the position signal, an analog-to-digital converter is suitably required, preferrably only one part which is being connected to the sensing inputs, one after another, by a time-division scheme. With the pulse width modulation control, the reverse force of the key can be modified ad libitum, not having only one single pressure threshold point within a narrow range. The “key profile” can be stored and configured individually for every user, for every tone color (piano, organ etc.), or it can be configured for every key (e.g. more strained for the bass range) too.

A description in more detail by means of embodiments follows, in conjunction with the drawing.

### BRIEF DESCRIPTION OF THE DRAWINGS

FIG. 1 shows a first embodiment of the invention.

FIG. 2 shows a second embodiment of the invention.

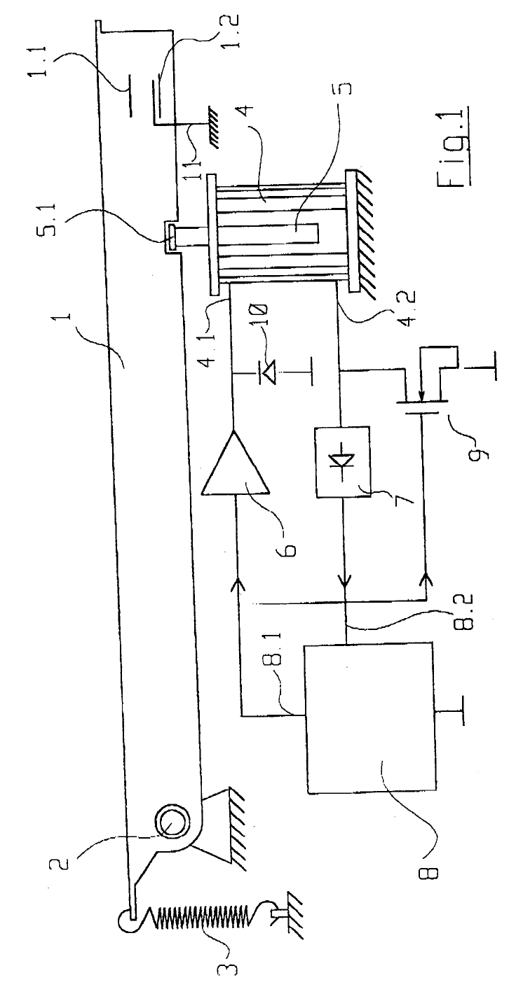

In FIG. 1 a key 1 is anchored by a pivot 2 and preloaded by spring 3. The key is mechanically coupled to a plunger 5 of a solenoid coil 4. The first terminal 4.1 of the solenoid coil is fed by pulse-width-modulated signals from a microprocessing unit 8, by its signal output 8.1 and a driver circuit 6. A reverse-biased diode 10 serves to decouple a (negative) reverse voltage which is shunted off to ground and protects the driver circuit 6. The second terminal of the solenoid coil 4 is on the one hand connected to ground by a vertical field-effect transistor (VFET) 9 and on the other hand connected to a sense input 8.2 of the microprocessing unit 8 by a diode 7. The control gate input of the transistor 9 is connected with the signal output 8.1 of the microprocessing unit 8. At positive signal output from the microprocessing unit 8, the transistor 9 is conducting and connects the terminal 4.2 of the solenoid coil 4 to ground, respectively. A positive control pulse pushes the plunger 5 towards the key 1, with the force being dependent from the time duration (width) of the control pulses. During pulse pauses, the transistor 9 is non-conductive. The reverse bias voltage (back EMF) induced within the solenoid coil 4 causes the generation of a voltage with reverse polarity at both terminals 4.1 and 4.2 of the solenoid coil so that a current is flowing from ground by diode 10, solenoid coil 4, and diode 7 to terminal 8.2, which is evaluated by microprocessing unit 8. The current or voltage progress can be evaluated as well, both decreasing exponentially in the main.

The voltage pulse or current pulse induced by the back EMF, respectively, is dependent from the relative position of the plunger 5 to the solenoid coil, therefore being a measure for the key actuation. With an appropriate frequent or fast scanning, respectively, the dynamic behaviour, like fast or slowly pressing down of the key, can be evaluated from this also. After that, the microprocessing unit 8 is able to vary the width of the control pulses, defining the characteristics of the key.

The signal arriving at terminal 8.2 is of analog shape and has to be converted from analog to digital, prior to further processing within the microprocessoing unit. For that, an external analog-to-digital converter can be provided which is not shown here, or an ADC integrated within the microprocessing unit 8, as it is shown in FIG. 1.

The key 1 additionally has two stopper elements which limit the the upper and lower end position of the key, together with a stopper element which is locally attached, in contrary to the key. The spring 3 is pulling the key 1 upwards, when the solenoid coil is not excited, until the stopper 1.2 comes into effect. The stopper 1.1 for the lower limit position also could be formed by the plunger 5, in theory. However, to reduce the mechanical strain, it is preferable to limit the lower position by a separate mechanical stopper too. The coupling of the plunger 5 of the solenoid coil to the key 1 can be realized by a damper element 5.1 which has elastic and damping attributes. The plunger 5 can be pressed upwards by a not shown spring positioned within the solenoid coil 4. This spring then may take over the function of the spring 3 which is shown in FIG. 1. Finally, damping elements, like felt, rubber, or other damping and elastic operating materials, may be attached to the stoppers 1.1 and 1.2 or to the stopper arm 11.

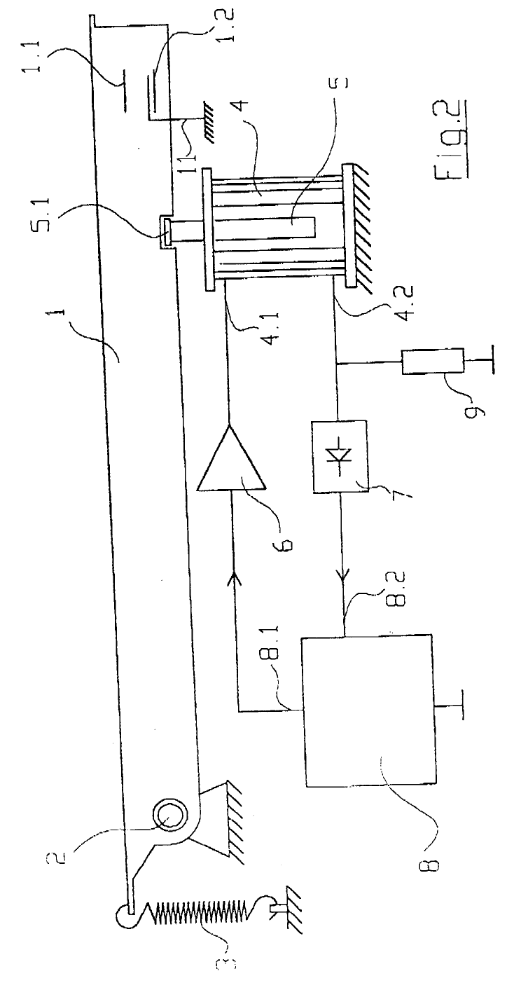

The embodiment of FIG. 2 differs from that of FIG. 1 essentially from the type of schematic in that the sensing of the key position takes place by the solenoid coil 4 during the active phase of the control signal at the terminal 4.1. During the active phase, a current is flowing via the driver circuit 6 through the solenoid coil, from there partially via resistor 9 to ground and partially via the forward-biased diode 7 to the microprocessing unit. The resistor 9 has a low resistance value. Therefore, on principle, the voltage drop across resistor 9 can be sensed at terminal 8.2 of the microprocessing unit. Essentially, the diode 7 serves here as an decoupling diode too. Its voltage drop can be neglected. Here too, the input signal at the terminal 8.2 is converted from analog to digital and evaluated.

In both embodiments, the microprocessing unit 8 contains a programmable memory, where the key characteristics are stored, respectively, i.e. a function of the coherence between the key position and the pulse width of the control signals. This function can be equal for all keys, which reduces the expense of storage. It can also be different for individual groups of keys, for example low, middle, and high tones. Finally, it can be stored individually for every key, with each key having different characteristics, at extreme cases. Additionally, different characteristics for the whole keyboard can be stored, e.g. piano, organ, electronic keyboard, cembalo etc. The control circuit 8 also may have an interface which is not shown, by which the control circuit is connectable to a PC or to other input devices, so that the user may program the characteristics by himself, at his personal preferences.

1. A keyboard for electronic musical instruments having several keys, to every of which an electrical magnet is assigned, whose anchor is coupled with the respective key and having a control circuit controlling said electric magnet in dependence from the position of the individual key in such a way that it exerts a predetermined force on said key, characterised in that
said electromagnet is designed to be simultaneously a sensor for monitoring the key position by the feature that the control circuit (8) is evaluating an electrical parameter (current or voltage) of the electric magnet (4).

2. A keyboard according to claim 1, characterised in that said control circuit is feeding said electromagnet (4) with pulse/pause modulated signals.

3. A keyboard according to claim 2 characterised in that the pulse width of said control signals is modified according to a predetermined stored function in dependence from the key position.

4. A keyboard according to claim 2 or 3 characterised in that the monitoring of the key position is performed during pulse pauses of said control signals by evaluating a reverse voltage induced within the coil of the electromagnet (4).

5. A keyboard according to claim 4 characterised in that a ground terminal (4.2) of the electromagnet is connected via an electronic switch (9) with ground,
in that a control input of said switch (9) is connected with a terminal (8.1) of said control circuit (8) providing for the control signals of the electromagnet in such a way that during a active phase of the control circuit said switch (9) is opened and during pulse pauses it is closed,
in that a ground terminal (4.2) of said electromagnet (4) is connected with an evaluation input (8.1) of said control circuit (8) and
in that the other terminal (4.1) of said electromagnet (4) is connected with said control terminal (8.1) of the control circuit (8) as well as via a reverse-biased diode (10) with ground.

6. A keyboard according to claim 3 or 4 characterised in that said control circuit is evaluating the run of a current flowing through that magnet coil during the active phase of the control signal.

7. A keyboard according to claim 6 characterised in that a terminal (4.1) of the electromagnet (4) is connected with said control terminal (8.1) of the control circuit (8) and in that the other terminal (4.2) of the electromagnet is connected via a low ohmig resistor (9) with ground as well as with an evaluation terminal (8.2) of the control circuit (8).

8. A keyboard according to one of claims 1 to 7 characterised in that said key (1) is forward loaded by a return spring (3) towards an upper limit position.

9. A keyboard according to one of claims 1 to 8 characterised in that said key contains upper and lower stopper elements (1.1, 1.2), which define an upper and lower position limit of said key together with a stopper arm (11) locally fixed with respect to said key.

10. A keyboard according to one of claims 1 to 9 characterised in that said stopper elements (1.1, 1.2) and/or said stopper arm (11) and/or the ancor (5) of said electromagnet (4), each comprise spring elastic damping elements (5.1).
